(19) United States
(12) Patent Application Publication
(10) Pub. No.: US 2010/0315014 A1
(43) Pub. Date: Dec. 16, 2010

(54) LED light string

(76) Inventors: Cheng-Fen Chang, Hsinchu City (TW); Chen-Hsien Chang, Hsinchu City (TW); Chen-Tao Chang, Hsinchu City (TW)

Correspondence Address: BACON & THOMAS, PLLC, 625 SLATERS LANE, FOURTH FLOOR, ALEXANDRIA, VA, 22314-1176, US

(21) Appl. No.: 12/457,566

(22) Filed: Jun. 16, 2009

(51) Int. Cl. H05B 37/00

(52) U.S. Cl. 315/192

(57) ABSTRACT

An electrical circuit for use as a string of lights in one embodiment includes a full-wave rectifier for converting an electrical source of AC into DC; and a load comprising a plurality of lamps connected in series, each of the lamps comprising an LED, a loading member in parallel with the LED, and a conductor interconnecting the LED and the loading member. The loading member is either a bidirectional Zener diode or a resistor element.

### BACKGROUND OF THE INVENTION

1. Field of Invention

The invention relates to providing electrical power to a plurality of low voltage electrical loads, and more particularly to a string of LED (light-emitting diode) light with improved characteristics.

2. Description of Related Art

LEDs are renowned for their long life and their ability to resist shock. Also, an LED consumes much less electrical power than fluorescent lamps (i.e., energy saving). Therefore, LED lighting devices are gaining popularity worldwide.

A typical string of lights including a plurality of LED bulbs arranged electrically in a series circuit is shown in FIG. 1. AC (alternating current) 120V is rectified by a full-wave rectifier (e.g., bridge rectifier) to convert into DC (direct current) which is to be consumed by the plurality of LED bulbs. However, the well known light string suffers from a disadvantage. In detail, one LED bulb of the string burning out will kill the circuit. For example, the light string comprises 40 blue LED bulbs of 3V 0.02 A. Any burned out blue LED bulb will kill the circuit with the remaining 39 blue LED bulbs being disabled.

Another typical string of lights including a plurality of (e.g., 35) white LED bulbs of 3.2V 0.02 A arranged electrically in a parallel circuit is shown in FIG. 2. It has the advantage of maintaining the circuit in a normal operation except all LED bulbs are burned out. That is, for example, one burned out LED bulb will not kill the circuit.

However, the well known light string still suffers from a disadvantage. In detail, electric current is required to increase as the number of LED bulbs increases. The total current (e.g., I) of the circuit can be expressed as a multiplication of current (e.g., I_{F}) flowing through each LED bulb times the number of LED bulbs (e.g., N). As shown, AC 120V is rectified by a full-wave rectifier 9 to convert into DC (e.g., DC 3.5V 0.7 A) to be consumed by the 35 white LED bulbs. For example, operating voltage of the white LED bulb is 3.2V and operating current thereof is 0.7 A. Hence, the total current (I) is 0.02 A×35 equal to 0.7 A. Advantageously, the circuit will maintain its normal operation if, for example, one white LED bulb is burned out. That is, the remaining 34 white LED bulbs still emit light. However, it is impossible of attaching at least 35 or even at least 60 LED bulbs to the light string. That is, the number of LED bulbs may be insufficient for some applications.

There have been numerous suggestions in prior patents for light string. For example, U.S. Pat. No. 6,344,716 discloses a Christmas light string. Thus, continuing improvements in the exploitation of light string employing LED bulbs are constantly being sought.

### SUMMARY OF THE INVENTION

It is therefore one object of the invention to provide an electrical circuit for use as a string of lights electrically connected to an electrical source of AC (alternating current), comprising a load comprising a plurality of lamps connected in series, each of the lamps comprising an LED, a loading member in parallel with the LED, and a conductor interconnecting the LED and the loading member.

It is another object of the invention to provide an electrical circuit for use as a string of lights, comprising a half-wave rectifier for converting an electrical source of AC (alternating current) into DC (direct current); and a load comprising a plurality of lamps connected in series, each of the lamps comprising an LED, a loading member in parallel with the LED, and a conductor interconnecting the LED and the loading member.

It is a further object of the invention to provide an electrical circuit for use as a string of lights, comprising a full-wave rectifier for converting an electrical source of AC (alternating current) into DC (direct current); and a load comprising a plurality of lamps connected in series, each of the lamps comprising an LED, a loading member in parallel with the LED, and a conductor interconnecting the LED and the loading member.

The above and other objects, features and advantages of the invention will become apparent from the following detailed description taken with the accompanying drawings.

### BRIEF DESCRIPTION OF THE DRAWINGS

FIG. 1 is a circuit diagram of a typical LED light string with lamps arranged in series;

FIG. 2 is a circuit diagram of another typical LED light string with lamps arranged in parallel;

FIG. 3 is a circuit diagram of a first preferred embodiment of string of lights according to the invention;

FIG. 4 is a circuit diagram of a second preferred embodiment of string of lights according to the invention;

FIG. 5 is a circuit diagram of a third preferred embodiment of string of lights according to the invention;

FIG. 6 is a circuit diagram of a fourth preferred embodiment of string of lights according to the invention;

FIG. 7 is a circuit diagram of a fifth preferred embodiment of string of lights according to the invention;

FIG. 8 is a circuit diagram of a sixth preferred embodiment of string of lights according to the invention;

FIG. 9 is a circuit diagram of a seventh preferred embodiment of string of lights according to the invention;

FIG. 10 is a circuit diagram of an eighth preferred embodiment of string of lights according to the invention;

FIG. 11 is a circuit diagram of a ninth preferred embodiment of string of lights according to the invention;

FIG. 12 is a circuit diagram of a tenth preferred embodiment of string of lights according to the invention;

FIG. 13 is a circuit diagram of an eleventh preferred embodiment of string of lights according to the invention;

FIG. 14 is a circuit diagram of a twelfth preferred embodiment of string of lights according to the invention; and

FIG. 15 is a circuit diagram of a thirteenth preferred embodiment of string of lights according to the invention.

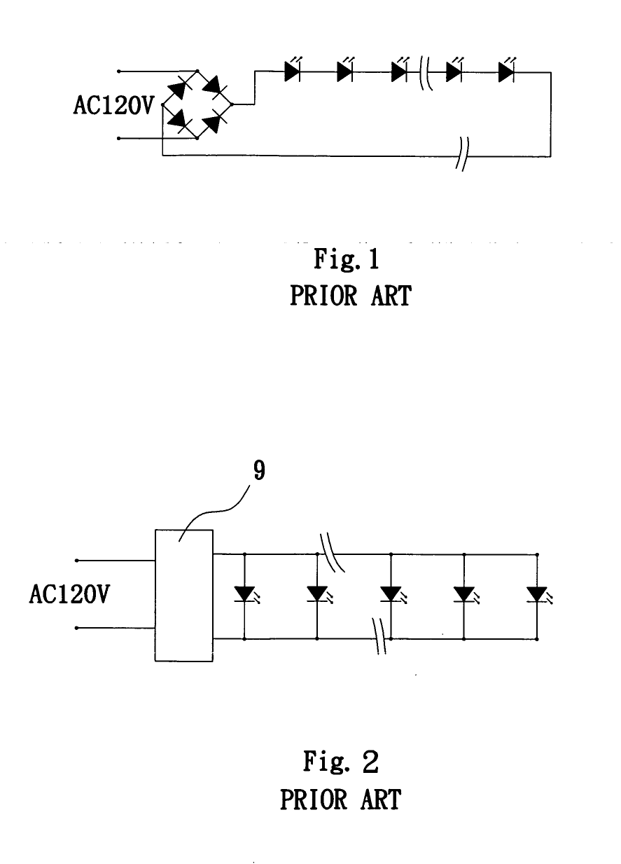

### DETAILED DESCRIPTION OF THE INVENTION

Referring to FIG. 3, a circuit diagram of a first preferred embodiment of string of lights according to the invention is shown. As shown, AC input is AC 120V which is supplied to a plurality of LEDs 3 electrically connected in series, and a plurality of bidirectional Zener diodes 2 electrically connected in series via a voltage reduction unit 1. The voltage reduction unit 1 is a resistor in this embodiment. Further, the bidirectional Zener diodes 2 are electrically connected in parallel with the LEDs 3. The number of the LEDs 3 is the same as that of the bidirectional Zener diodes 2. That is, there are a plurality of pairs of LED 3 and bidirectional Zener diode 2. A conductor 4 is employed to interconnect any two adjacent pairs of LED 3 and bidirectional Zener diode 2.

In this embodiment, the voltage reduction unit 1 may consume AC 30V, the LED 3 is of 3V 0.02 A (i.e., the LED 3 being adapted to emit light at an operating voltage of 3V and an operating current of 0.02 A), the bidirectional Zener diode 2 has a breakdown voltage of 3V in either direction, and the number of the pairs of LED 3 and bidirectional Zener diode 2 is 30. That is, AC 120V is consumed by both the voltage reduction unit 1 (e.g., AC 30V) and the bidirectional Zener diodes 2 (e.g., AC 90V). Advantageously, current will bypass any burned out LED 3 to flow through its parallel bidirectional Zener diode 2 via the conductor 4 interconnecting them (i.e., shunt). Hence, the circuit still can maintain a normal operation.

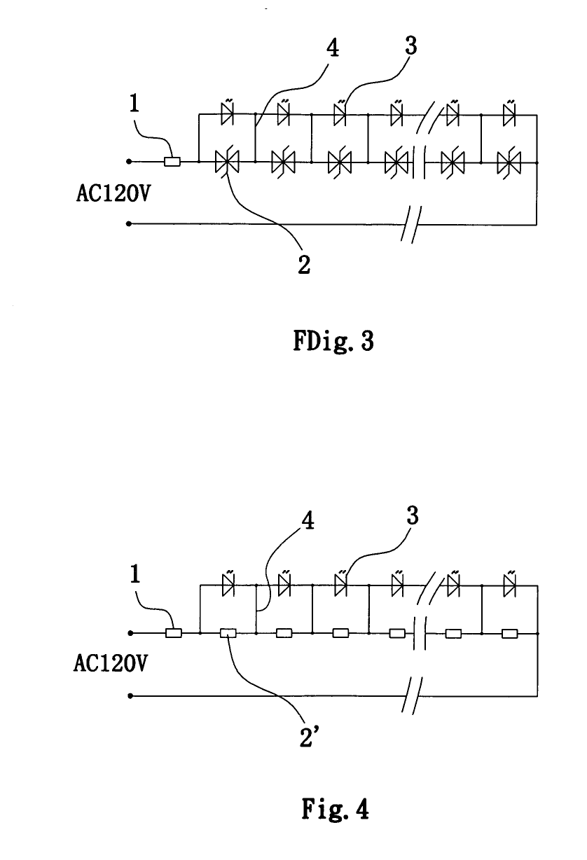

Referring to FIG. 4, a circuit diagram of a second preferred embodiment of string of lights according to the invention is shown. As shown, AC input is AC 120V which is supplied to a plurality of LEDs 3 electrically connected in series, and a plurality of resistors 2′ electrically connected in series via a voltage reduction unit 1. The voltage reduction unit 1 is a resistor in this embodiment. Further, the resistors 2′ are electrically connected in parallel with the LEDs 3. The number of the LEDs 3 is the same as that of the resistors 2′. That is, there are a plurality of pairs of LED 3 and resistor 2′. A conductor 4 is employed to interconnect any two adjacent pairs of LED 3 and resistor 2′.

In this embodiment, the voltage reduction unit 1 may consume AC 45V, the LED 3 is of 3V 0.02 A (i.e., the LED 3 being adapted to emit light at an operating voltage of 3V and an operating current of 0.02 A), the resistor 2′ may consume AC 3V, and the number of the pairs of LED 3 and resistor 2′ is 25. That is, AC 120V is consumed by the voltage reduction unit 1 (e.g., AC 45V) and the resistors 2′ (e.g., AC 75V). Advantageously, current will bypass any burned out LED 3 to flow through its parallel resistor 2′ via the conductor 4 interconnecting them (i.e., shunt). Hence, the circuit still can maintain a normal operation.

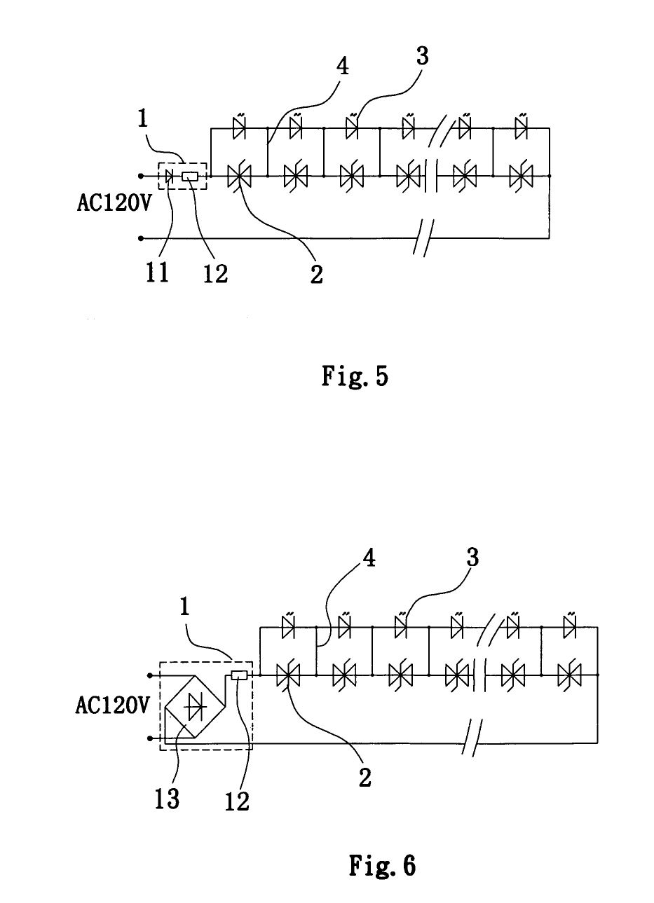

Referring to FIG. 5, a circuit diagram of a third preferred embodiment of string of lights according to the invention is shown. As shown, AC input is AC 120V which is rectified by a voltage reduction unit 1 comprising a rectifier diode 11 and a resistor 12 electrically connected in series thereto, i.e., the voltage reduction unit 1 is implemented as a half-wave rectifier. DC 60V is supplied from the voltage reduction unit 1 to a plurality of LEDs 3 electrically connected in series and a plurality of bidirectional Zener diodes 2 electrically connected in series. Further, the bidirectional Zener diodes 2 are electrically connected in parallel with the LEDs 3. The number of the LEDs 3 is the same as that of the bidirectional Zener diodes 2. That is, there are a plurality of pairs of LED 3 and bidirectional Zener diode 2. A conductor 4 is employed to interconnect any two adjacent pairs of LED 3 and bidirectional Zener diode 2.

In this embodiment, the LED 3 is of 3V 0.02 A (i.e., the LED 3 being adapted to emit light at an operating voltage of 3V and an operating current of 0.02 A), the bidirectional Zener diode 2 has a breakdown voltage of 3V in either direction, and the number of the pairs of LED 3 and bidirectional Zener diode 2 is 20. That is, DC 60V output is consumed by the bidirectional Zener diodes 2. Advantageously, current will bypass any burned out LED 3 to flow through its parallel bidirectional Zener diode 2 via the conductor 4 interconnecting them (i.e., shunt). Hence, the circuit still can maintain a normal operation.

Referring to FIG. 6, a circuit diagram of a fourth preferred embodiment of string of lights according to the invention is shown. As shown, AC input is AC 120V which is rectified by a voltage reduction unit 1 comprising a full-wave rectifier (e.g., bridge rectifier) 13 and a resistor 12 electrically connected in series thereto. DC 60V is supplied from the voltage reduction unit 1 to a plurality of LEDs 3 electrically connected in series and a plurality of bidirectional Zener diodes 2 electrically connected in series. Further, the bidirectional Zener diodes 2 are electrically connected in parallel with the LEDs 3. The number of the LEDs 3 is the same as that of the bidirectional Zener diodes 2. That is, there are a plurality of pairs of LED 3 and bidirectional Zener diode 2. A conductor 4 is employed to interconnect any two adjacent pairs of LED 3 and bidirectional Zener diode 2.

In this embodiment, the LED 3 is of 3V 0.02 A (i.e., the LED 3 being adapted to emit light at an operating voltage of 3V and an operating current of 0.02 A), the bidirectional Zener diode 2 has a breakdown voltage of 3V in either direction, and the number of the pairs of LED 3 and bidirectional Zener diode 2 is 20. That is, DC 60V output is consumed by the bidirectional Zener diodes 2. Advantageously, current will bypass any burned out LED 3 to flow through its parallel bidirectional Zener diode 2 via the conductor 4 interconnecting them (i.e., shunt). Hence, the circuit still can maintain a normal operation.

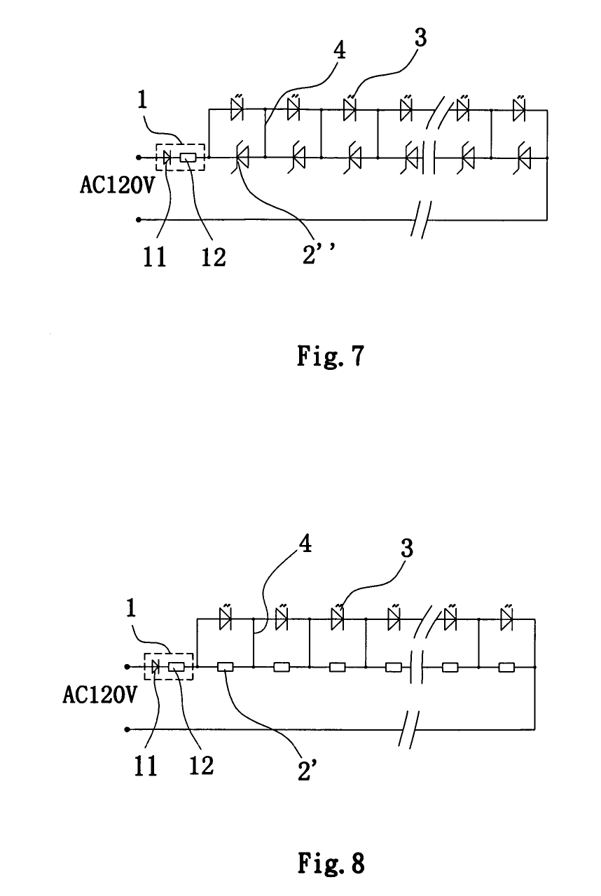

Referring to FIG. 7, a circuit diagram of a fifth preferred embodiment of string of lights according to the invention is shown. As shown, AC input is AC 120V which is rectified by a voltage reduction unit 1 comprising a rectifier diode 11 and a resistor 12 electrically connected in series thereto, i.e., the voltage reduction unit 1 is implemented as a half-wave rectifier. DC 60V is supplied from the voltage reduction unit 1 to a plurality of LEDs 3 electrically connected in series and a plurality of Zener diodes 2″ electrically connected in series. Further, the Zener diodes 2″ are electrically connected in parallel with the LEDs 3. The number of the LEDs 3 is the same as that of the bidirectional Zener diodes 2. That is, there are a plurality of pairs of LED 3 and Zener diode 2″. A conductor 4 is employed to interconnect any two adjacent pairs of LED 3 and Zener diode 2″.

In this embodiment, the LED 3 is of 3V 0.02 A (i.e., the LED 3 being adapted to emit light at an operating voltage of 3V and an operating current of 0.02A), the Zener diode 2″ has a breakdown voltage of 3V when being forward biased, and the number of the pairs of LED 3 and Zener diode 2″ is 20. That is, DC 60V output is consumed by the Zener diodes 2″. Advantageously, current will bypass any burned out LED 3 to flow through its parallel Zener diode 2″ via the conductor 4 interconnecting them (i.e., shunt). Hence, the circuit still can maintain a normal operation.

Referring to FIG. 8, a circuit diagram of an sixth preferred embodiment of string of lights according to the invention is shown. As shown, AC input is AC 120V which is rectified by a voltage reduction unit 1 comprising a rectifier diode 11 and a resistor 12 electrically connected in series thereto, i.e., the voltage reduction unit 1 is implemented as a half-wave rectifier. DC 60V is supplied from the voltage reduction unit 1 to a plurality of LEDs 3 electrically connected in series and a plurality of resistors 2′ electrically connected in series. Further, the resistors 2′ are electrically connected in parallel with the LEDs 3. The number of the LEDs 3 is the same as that of the resistors 2′. That is, there are a plurality of pairs of LED 3 and resistor 2′. A conductor 4 is employed to interconnect any two adjacent pairs of LED 3 and resistor 2′.

In this embodiment, the LED 3 is of 3V 0.02 A (i.e., the LED 3 being adapted to emit light at an operating voltage of 3V and an operating current of 0.02 A), the resistor 2′ may consume DC 3V, and the number of the pairs of LED 3 and resistor 2′is 20. That is, DC 60V output is consumed by the resistors 2′. Advantageously, current will bypass any burned out LED 3 to flow through its parallel resistor 2′ via the conductor 4 interconnecting them (i.e., shunt). Hence, the circuit still can maintain a normal operation.

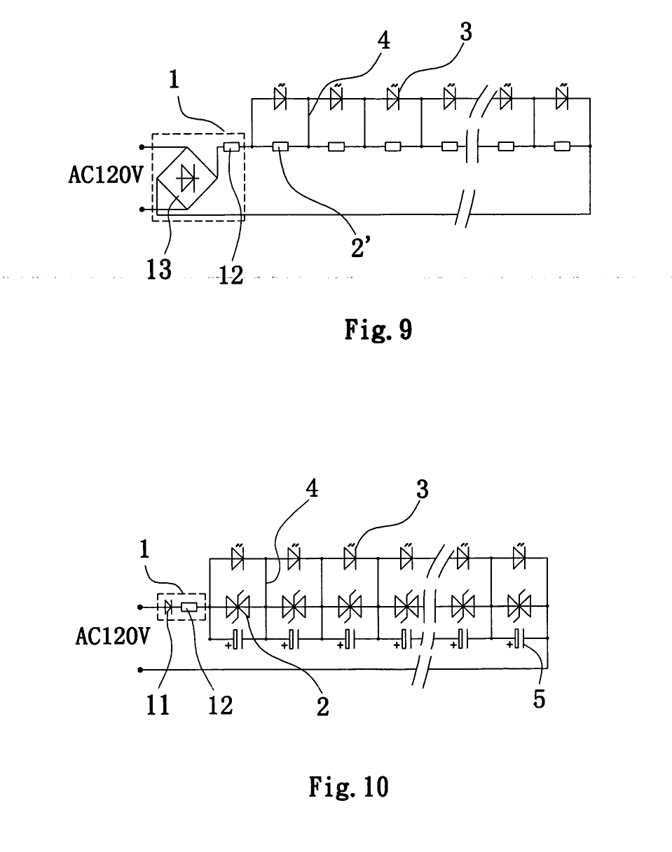

Referring to FIG. 9, a circuit diagram of a seventh preferred embodiment of string of lights according to the invention is shown. As shown, AC input is AC 120V which is rectified by a voltage reduction unit 1 comprising a full-wave rectifier (e.g., bridge rectifier) 13 and a resistor 12 electrically connected in series thereto. DC 50V is supplied from the voltage reduction unit 1 to a plurality of LEDs 3 electrically connected in series and a plurality of resistors 2′ electrically connected in series. Further, the resistors 2′ are electrically connected in parallel with the LEDs 3. The number of the LEDs 3 is the same as that of the resistors 2′. That is, there are a plurality of pairs of LED 3 and resistor 2′. A conductor 4 is employed to interconnect any two adjacent pairs of LED 3 and resistor 2′.

In this embodiment, the LED 3 is of 2V 0.02 A (i.e., the LED 3 being adapted to emit light at an operating voltage of 2V and an operating current of 0.02 A), the resistor 2′ may consume AC 2V, and the number of the pairs of LED 3 and resistor 2′ is 25. That is, DC 50V output is consumed by the resistors 2′. Advantageously, current will bypass any burned out LED 3 to flow through its parallel resistor 2′ via the conductor 4 interconnecting them (i.e., shunt). Hence, the circuit still can maintain a normal operation.

Referring to FIG. 10, a circuit diagram of an eighth preferred embodiment of string of lights according to the invention is shown. As shown, AC input is AC 120V which is rectified by a voltage reduction unit 1 comprising a rectifier diode 11 and a resistor 12 electrically connected in series thereto, i.e., the voltage reduction unit 1 is implemented as a half-wave rectifier. DC 70V is supplied from the voltage reduction unit 1 to a plurality of LEDs 3 electrically connected in series, a plurality of bidirectional Zener diodes 2 electrically connected in series, and a plurality of capacitors 5 electrically connected in series. Further, the bidirectional Zener diodes 2 are electrically connected in parallel with the LEDs 3 and the bidirectional Zener diodes 2 are electrically connected in parallel with the capacitors 5. The number of the LEDs 3 is the same as that of each of the bidirectional Zener diodes 2 and the capacitors 5. That is, there are a plurality of sets of LED 3, bidirectional Zener diode 2, and capacitor 5. A conductor 4 is employed to interconnect any two adjacent sets of LED 3, bidirectional Zener diode 2, and capacitor 5. Note that the provision of the capacitor 5 can prevent the voltage across its terminals (i.e., bidirectional Zener diode's terminals) from changing.

In this embodiment, the LED 3 is of 2V 0.02 A (i.e., the LED 3 being adapted to emit light at an operating voltage of 2V and an operating current of 0.02 A), the bidirectional Zener diode 2 has a breakdown voltage of 2V in either direction, and the number of the sets of LED 3, the bidirectional Zener diode 2, and the capacitor 5 is 35. That is, DC 70V output is consumed by the bidirectional Zener diodes 2. Advantageously, current will bypass any burned out LED 3 to flow through its parallel bidirectional Zener diode 2 via the conductor 4 interconnecting them (i.e., shunt). Hence, the circuit still can maintain a normal operation.

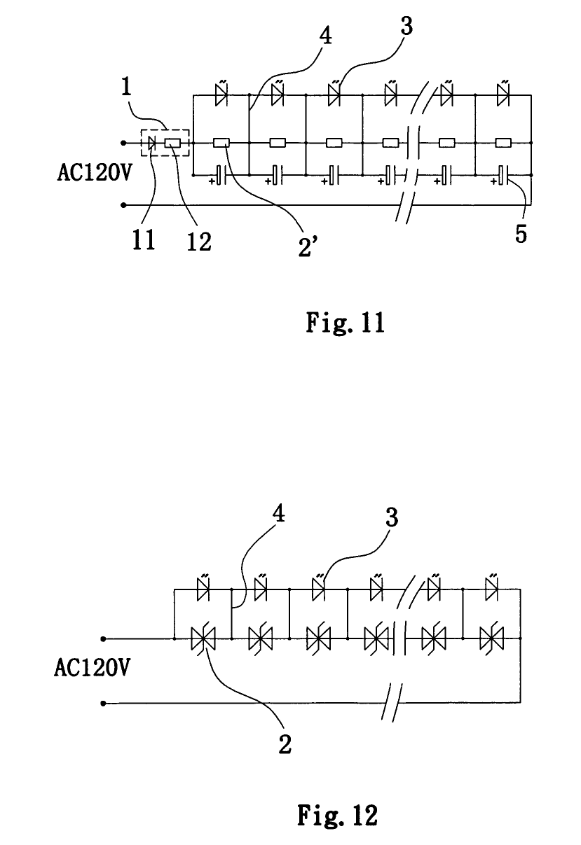

Referring to FIG. 11, a circuit diagram of a ninth preferred embodiment of string of lights according to the invention is shown. As shown, AC input is AC 120V which is rectified by a voltage reduction unit 1 comprising a rectifier diode 11 and a resistor 12 electrically connected in series thereto, i.e., the voltage reduction unit 1 is implemented as a half-wave rectifier. DC 105V is supplied from the voltage reduction unit 1 to a plurality of LEDs 3 electrically connected in series, a plurality of resistors 2′ electrically connected in series, and a plurality of capacitors 5 electrically connected in series. Further, the resistors 2′ are electrically connected in parallel with the LEDs 3 and the resistors 2′ are electrically connected in parallel with the capacitors 5. The number of the LEDs 3 is the same as that of each of the resistors 2′ and the capacitors 5. That is, there are a plurality of sets of LED 3, resistor 2′, and capacitor 5. A conductor 4 is employed to interconnect any two adjacent sets of LED 3, resistor 2′, and capacitor 5. Note that the provision of the capacitor 5 can prevent the voltage across its terminals (i.e., resistor's terminals) from changing.

In this embodiment, the LED 3 is of 3V 0.02 A (i.e., the LED 3 being adapted to emit light at an operating voltage of 3V and an operating current of 0.02 A), the resistor 2′ may consume DC 3V, and the number of the sets of LED 3, resistor 2′, and capacitor 5 is 35. That is, DC 105V output is consumed by the resistors 2′. Advantageously, current will bypass any burned out LED 3 to flow through its parallel resistor 2′ via the conductor 4 interconnecting them (i.e., shunt). Hence, the circuit still can maintain a normal operation.

Referring to FIG. 12, a circuit diagram of a tenth preferred embodiment of string of lights according to the invention is shown. As shown, AC input is AC 120V which is supplied to a plurality of LEDs 3 electrically connected in series, and a plurality of bidirectional Zener diodes 2 electrically connected in series. Further, the bidirectional Zener diodes 2 are electrically connected in parallel with the LEDs 3. The number of the LEDs 3 is the same as that of the bidirectional Zener diodes 2. That is, there are a plurality of pairs of LED 3 and bidirectional Zener diode 2. A conductor 4 is employed to interconnect any two adjacent pairs of LED 3 and bidirectional Zener diode 2.

In this embodiment, the LED 3 is of 3V 0.02 A (i.e., the LED 3 being adapted to emit light at an operating voltage of 3V and an operating current of 0.02 A), the bidirectional Zener diode 2 has a breakdown voltage of 3V in either direction, and the number of the pairs of LED 3 and bidirectional Zener diode 2 is 40. That is, AC 120V is consumed by the bidirectional Zener diodes 2. Advantageously, current will bypass any burned out LED 3 to flow through its parallel bidirectional Zener diode 2 via the conductor 4 interconnecting them (i.e., shunt). Hence, the circuit still can maintain a normal operation.

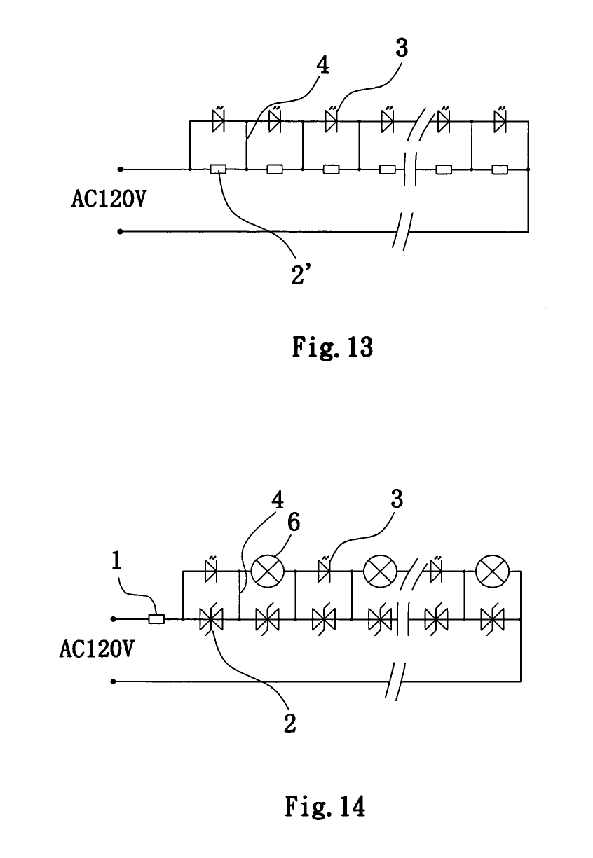

Referring to FIG. 13, a circuit diagram of an eleventh preferred embodiment of string of lights according to the invention is shown. As shown, AC input is AC 120V which is supplied to a plurality of LEDs 3 electrically connected in series, and a plurality of resistors 2′ electrically connected in series. Further, the resistors 2′ are electrically connected in parallel with the LEDs 3. The number of the LEDs 3 is the same as that of the resistors 2′. That is, there are a plurality of pairs of LED 3 and resistor 2′. A conductor 4 is employed to interconnect any two adjacent pairs of LED 3 and resistor 2′.

In this embodiment, the LED 3 is of 2V 0.02 A (i.e., the LED 3 being adapted to emit light at an operating voltage of 2V and an operating current of 0.02 A), the resistor 2′ may consume DC 2V, and the number of the pairs of LED 3 and resistor 2′ is 60. That is, AC 120V is consumed by the resistors 2′. Advantageously, current will bypass any burned out LED 3 to flow through its parallel resistor 2′ via the conductor 4 interconnecting them (i.e., shunt). Hence, the circuit still can maintain a normal operation.

Referring to FIG. 14, a circuit diagram of a twelfth preferred embodiment of string of lights according to the invention is shown. As shown, AC input is AC 120V which is supplied to a plurality of alternate LEDs 3 and incandescent lamps 6 electrically connected in series, and a plurality of bidirectional Zener diodes 2 electrically connected in series. Further, the bidirectional Zener diodes 2 are electrically connected in parallel with the alternate LEDs 3 and incandescent lamps 6. The number of the LEDs 3 (or the incandescent lamps 6) is half as that of the bidirectional Zener diodes 2. That is, there are a plurality of pairs each consisting of either (i) a bidirectional Zener diode 2 and an LED 3 or (ii) a bidirectional Zener diode 2 and an incandescent lamp 6. A conductor 4 is employed to interconnect any pair of LED 3 and bidirectional Zener diode 2 and an adjacent pair of incandescent lamp 6 and bidirectional Zener diode 2.

In this embodiment, the LED 3 is of 3V 0.02 A (i.e., the LED 3 being adapted to emit light at an operating voltage of 3V and an operating current of 0.02 A), the bidirectional Zener diode 2 has a breakdown voltage of 3V in either direction, the incandescent lamp 6 is of 3V 0.1 A, and the number of the pairs of LED 3 and bidirectional Zener diode 2 plus the number of the pairs of incandescent lamp 6 and bidirectional Zener diode 2 is 40. That is, AC 120V is consumed by the bidirectional Zener diodes 2. Advantageously, current will bypass any burned out LED 3 or incandescent lamp 6 to flow through its parallel bidirectional Zener diode 2 via the conductor 4 interconnecting them (i.e., shunt). Hence, the circuit still can maintain a normal operation.

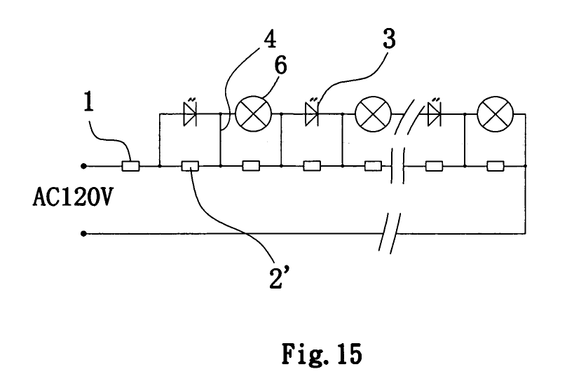

Referring to FIG. 15, a circuit diagram of a thirteenth preferred embodiment of string of lights according to the invention is shown. As shown, AC input is AC 120V which is supplied to a plurality of alternate LEDs 3 and incandescent lamps 6 electrically connected in series, and a plurality of resistors 2′ electrically connected in series. Further, the resistors 2′ are electrically connected in parallel with the alternate LEDs 3 and incandescent lamps 6. The number of the LEDs 3 (or the incandescent lamps 6) is half as that of the resistors 2′. That is, there are a plurality of pairs each consisting of either (i) a resistor 2′ and an LED 3 or (ii) a resistor 2′ and an incandescent lamp 6. A conductor 4 is employed to interconnect any pair of LED 3 and resistor 2′ and an adjacent pair of incandescent lamp 6 and resistor 2′.

In this embodiment, the LED 3 is of 3V 0.02 A (i.e., the LED 3 being adapted to emit light at an operating voltage of 3V and an operating current of 0.02 A), the resistor 2′ may consume 3V, the incandescent lamp 6 is of 3V 0.1 A, and the number of the pairs of LED 3 and resistor 2′ plus the number of the pairs of incandescent lamp 6 and resistor 2′ is 40. That is, AC 120V is consumed by the resistors 2′. Advantageously, current will bypass any burned out LED 3 or incandescent lamp 6 to flow through its parallel resistor 2′ via the conductor 4 interconnecting them (i.e., shunt). Hence, the circuit still can maintain a normal operation.

While the invention herein disclosed has been described by means of specific embodiments, numerous modifications and variations could be made thereto by those skilled in the art without departing from the scope and spirit of the invention set forth in the claims.

What is claimed is:

1. An electrical circuit for use as a string of lights electrically connected to an electrical source of AC (alternating current), comprising:
a load comprising a plurality of lamps connected in series, each of the lamps comprising an LED, a loading member in parallel with the LED, and a conductor interconnecting the LED and the loading member.

2. The electrical circuit of claim 1, further comprising a resistor inserted between the electrical source of AC and the load, and wherein each of the loading members is a bidirectional Zener diode.

3. The electrical circuit of claim 1, further comprising a resistor inserted between the electrical source of AC and the load, and wherein each of the loading members is a resistor element.

4. The electrical circuit of claim 1, wherein each of the loading members is a bidirectional Zener diode.

5. The electrical circuit of claim 1, wherein each of the loading members is a resistor element.

6. An electrical circuit for use as a string of lights, comprising:
a half-wave rectifier for converting an electrical source of AC (alternating current) into DC (direct current); and
a load comprising a plurality of lamps connected in series, each of the lamps comprising an LED, a loading member in parallel with the LED, and a conductor interconnecting the LED and the loading member.

7. The electrical circuit of claim 6, wherein each of the loading members is a bidirectional Zener diode.

8. The electrical circuit of claim 6, wherein each of the loading members is a Zener diode.

9. The electrical circuit of claim 6, wherein each of the loading members is a resistor element.

10. The electrical circuit of claim 6, wherein the loading member comprises a plurality of bidirectional Zener diodes connected in series, and a plurality of capacitors connected in series, and wherein each of the conductors interconnects the bidirectional Zener diode of the loading member and the capacitor thereof.

11. The electrical circuit of claim 6, wherein the loading member comprises a plurality of resistor elements connected in series, and a plurality of capacitors connected in series, and wherein each of the conductors interconnects the resistor element of the loading member and the capacitor thereof.

12. An electrical circuit for use as a string of lights, comprising:
a full-wave rectifier for converting an electrical source of AC (alternating current) into DC (direct current); and
a load comprising a plurality of lamps connected in series, each of the lamps comprising an LED, a loading member in parallel with the LED, and a conductor interconnecting the LED and the loading member.

13. The electrical circuit of claim 12, wherein each of the loading members is a bidirectional Zener diode.

14. The electrical circuit of claim 12, wherein each of the loading members is a resistor element.
